(19) United States
(12) Patent Application Publication
(10) Pub. No.: US 2017/0171147 A1
(43) Pub. Date: Jun. 15, 2017

(54) METHOD AND ELECTRONIC DEVICE FOR IMPLEMENTING DOMAIN NAME SYSTEM

(71) Applicants: Le Holdings (Beijing) Co., Ltd., Beijing (CN); LeCloud Computing Co., Ltd., Beijing (CN)

(72) Inventors: Ming LI, Beijing (CN); Ruiqian ZHAO, Beijing (CN)

(21) Appl. No.: 15/246,536

(22) Filed: Aug. 25, 2016

Related U.S. Application Data
(63) Continuation of application No. PCT/CN2016/089471, filed on Jul. 8, 2016.

(30) Foreign Application Priority Data
Dec. 10, 2015 (CN) 201510918961.5

(51) Int. Cl. H04L 29/12; H04L 29/06; H04L 29/08

(52) U.S. Cl. CPC H04L 61/1511; H04L 67/28; H04L 63/1466

(57) ABSTRACT

Disclosed are a method and an electronic device for implementing a domain name system. The method includes: receiving, by a transition server, a request from a client, wherein the transition server has preset IP addresses; forwarding the request to an execution server and receiving a domain name resolution result returned by the execution server; and returning the domain name resolution result to the client.

### CROSS REFERENCE TO RELATED APPLICATIONS

This application is a continuation of International Application No. PCT/CN2016/089471, filed on Jul. 8, 2016, which is based upon and claims priority to Chinese Patent Application No. 201510918961.5, filed on Dec. 10, 2015, the entire contents of all of which are incorporated herein by reference.

### TECHNICAL FIELD

The present disclosure relates to Internet technologies, and more particularly, to a method and an electronic device for implementing a domain name system.

### BACKGROUND

In a process of use of the Internet, users need an Internet Protocol (IP) address of a computer for normal communication. An IP address is a 32-bit binary number, and it is difficult for users to remember a large number of IP addresses. Therefore, it is inconvenient for users when the users directly use IP addresses for communication. To solve the foregoing problem, in the prior art, a Domain Name System (DNS) is used as a distributed database where domain names and IP addresses are mutually mapped, which can allow users to more conveniently access to the Internet without remembering IP strings that can be directly read by a machine. A process of finally obtaining an IP address corresponding to a host name by means of the host name is referred to as a domain name resolution.

A DNS is used for mapping a domain name to an IP address that can be recognized by a real computer so that the computer can further communicate, and transmit websites and contents or the like. A domain name hijacking (a DNS hijacking) often occurs. In a DNS hijacking, a domain name resolution request is intercepted within a hijacking network range, a domain name of the request is analyzed, a request beyond an examination scope is released, otherwise a false IP address is returned or nothing is done until loss of response to the request, the effect thereof is that a particular network cannot be reflected or false website is visited. Therefore, how to ensure a request not to be maliciously hijacked becomes a problem to be solved urgently to maintain services of Internet providers.

### SUMMARY

The present disclosure provides a method and an electronic device for implementing a domain name system to solve a defect in the prior art that a user's normal domain name access request is maliciously hijacked and to achieve an objective that a target address can be securely accessed through a normal HTTP request.

According to a first aspect of embodiments of the present disclosure, the embodiments of the present disclosure provide a method for implementing a domain name system, which is mainly used in a transition server, including:

receiving a request from a client, where the transition server has preset IP addresses;

forwarding the request to an execution server and receiving a domain name resolution result returned by the execution server; and

returning the domain name resolution result to the client.

According to a second aspect of embodiments of the present disclosure, the embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for implementing a domain name system mentioned by embodiments of the present disclosure.

According to a third aspect of embodiments of the present disclosure, the embodiments of the present disclosure provide an electronic device, including: at least one processor; and a memory communicably connected with the at least one processor for storing instructions executable by the at least one processor, wherein execution of the instructions by the at least one processor causes the at least one processor to:

receive a request forwarded by a transition server from a client;

search for a self-configured domain name resolution result corresponding to the request according to the request; and

return the domain name resolution result corresponding to the request to the transition server.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for implementing a domain name system in accordance with some embodiments;

FIG. 2 is a flowchart of another method for implementing a domain name system in accordance with some embodiments;

FIG. 3 is a composition block diagram of an apparatus for implementing a domain name system in accordance with some embodiments;

FIG. 4 is a composition block diagram of another apparatus for implementing a domain name system in accordance with some embodiments;

FIG. 5 is a composition block diagram of still another apparatus for implementing a domain name system in accordance with some embodiments;

FIG. 6 is a schematic structural diagram of a server in accordance with some embodiments; and

FIG. 7 is a block diagram of an electronic device which is configured to perform the methods for implementing a domain name system in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

As a distributed database where domain names and IP addresses are mutually mapped, a DNS can allow users to conveniently access to the Internet without remembering IP strings that can be directly read by a machine, and an IP address corresponding to a host name is finally obtained by means of the host name. In the prior art, a mapping of a host name to an IP address includes: 1) a static mapping, each device is configured with a mapping of a host to an IP address, each device independently maintains its own mapping table which is merely available for the device; and 2) a dynamic mapping, a set of domain name system (DNS) is established, a mapping of a host to an IP address is only configured on a special DNS server, a device that communicates by using a host name is required for a network, and first of all, an IP address corresponding to the host is searched for from the DNS server. When resolving a domain name, first of all, a method of static domain name resolution can be used, and then a method of dynamic domain name resolution is used if the static domain name resolution is failed. Due to the presence of the process of the foregoing domain name resolution, when the client sends a domain name resolution request, the request may be maliciously hijacked, and a false IP address may be returned to the client or the request may be not responded to.

To solve the above problem, embodiments of the present disclosure provide a method for implementing a domain name system, which is mainly used in a transition server, as shown in FIG. 1, the method includes following steps.

101: The transition server receives requests from a client, where the transition server has preset IP addresses.

In the embodiments of the present disclosure, the transition server receives requests sent by the client according to the preset IP addresses of the transition server, where the preset IP addresses are preset virtual IP addresses. For example, at least two preset virtual IP addresses are provided, and receiving by the transition server a request from the client includes: receiving, by the transition server, a request sent by the client according to different virtual IP addresses selected according to service types.

To avoid the occurrence of a DNS hijacking, in the embodiments of the present disclosure, a request from the client can be sent to the transition server based on a preset IP address, namely, an HTTP request sent by the client is directly sent to a preset IP address, and the request is sent to the transition server disposed in the embodiments of the present disclosure. Since a DNS resolution is not required for this process, a request from the client can be directly sent according to a preset IP address, and thus a false IP address may not be returned to the request from the client. For the abovementioned reason, in the embodiments of the present disclosure, a transition server having an IP address may be disposed, and a request from the client is received by the transition server.

102: The request is forwarded to an execution server and a domain name resolution result returned by the execution server is received.

In the embodiments of the present disclosure, forwarding the request to the execution server includes: the transition server forwards the request to a target execution server according to a load condition of the execution server; and the transition server forwards the request to a corresponding execution server according to a content of the request. In Step 101, it is required to receive a request from the client by the transition server. Therefore, all requests sent by the client can be received by the transition server having a preset IP address. In the embodiments of the present disclosure, the transition server only needs to receive a request from the client without resolving a domain name of the client. This is because the transition server is merely in charge of collecting requests from the client and forwarding the requests from the client to the execution server according to the requests and a load condition of the server, and the execution server is a server really executing a request from the client.

103: The domain name resolution result is returned to the client.

The corresponding domain name resolution result includes: operator information corresponding to an egress IP address as well as domain name and geographical location information configured. In the embodiments of the present disclosure, what really executes a request from the client is the execution server. Therefore, in the embodiments of the present disclosure, the transition server also needs to receive a domain name resolution result corresponding to the request from the client returned by the execution server, and transfer of the domain name resolution result is carried out by the transition server. Therefore, the client is allowed to see that the domain name resolution result comes from a preset IP address.

According to the method for implementing a domain name system provided by the embodiments of the present disclosure, requests can be uniformly sent by a client to a transition server based on preset IP addresses of the transition server, the received requests are forwarded by the transition server to an execution server, and a corresponding domain name resolution result is searched out from record information of the execution server and returned to the client. In the present disclosure, a request sent by the client can be directly sent based on preset IP addresses without a DNS resolution in the prior art, which effectively avoids a DNS hijacking occurred in a DNS resolution process, thereby achieving an objective that a target address can be securely accessed through a normal HTTP request of the client.

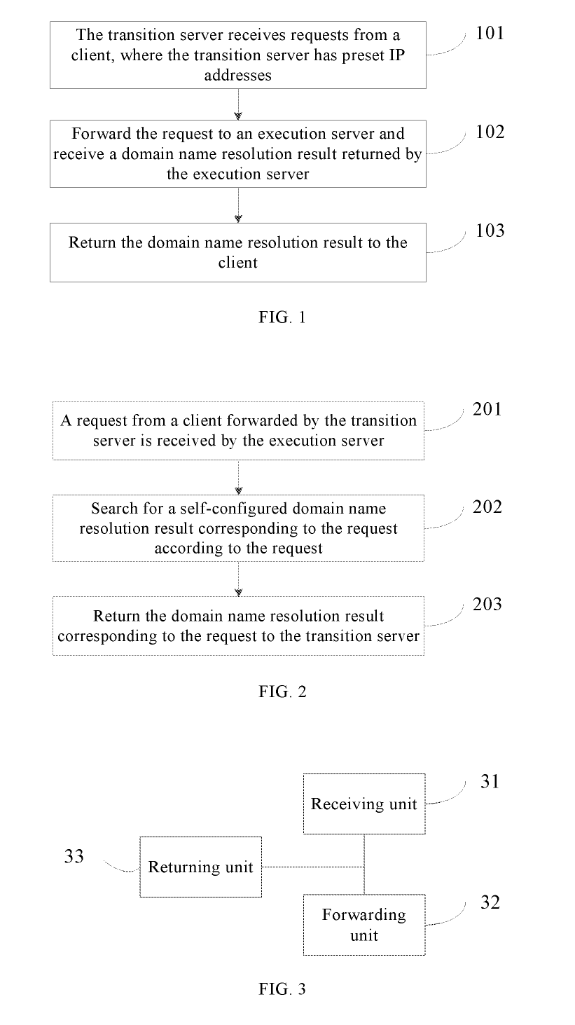

Corresponding to the method of the foregoing transition server, embodiments of the present disclosure further provide a method for implementing a domain name system, the method is mainly used in an execution server, as shown in FIG. 2, the method includes following steps.

201: A request from a client forwarded by the transition server is received by the execution server.

In the embodiments of the present disclosure, the transition server merely collects and transfers requests from the client, which are executed by the execution server. Therefore, the request from the client forwarded by the transition server is received by the execution server.

202: A self-configured domain name resolution result corresponding to the request is searched for according to the request.

In the embodiments of the present disclosure, what really executes a request from the client is the execution server. Therefore, the execution server saves record information of the domain name resolution result, namely, information in the execution server can be manually configured. In the embodiments of the present disclosure, the execution server can obtain operator information of the request as well as a real IP address and relevant geographical location information only by searching for a corresponding domain name resolution result from the execution server according to a domain name of the request.

203: The domain name resolution result corresponding to the request is returned to the transition server.

In order that the client can see that the domain name resolution result comes from a preset IP address used for sending a request, in the embodiments of the present disclosure, the domain name resolution result needs to be returned by the transition server to the client. However, what really searches the domain name resolution result out is the execution server. Therefore, the domain name resolution result needs to be first returned by the execution server to the transition server, and the domain name resolution result is forwarded by the transition server to the client. In this way, the client is allowed to see that the domain name resolution result comes from a preset IP address used for sending a request.

According to the method for implementing a domain name system provided by the embodiments of the present disclosure, requests can be uniformly sent by a client to a transition server based on preset IP addresses of the transition server, the received requests are forwarded by the transition server to an execution server, and a corresponding domain name resolution result is searched out from record information of the execution server and returned to the client. In the present disclosure, a request sent by the client can be directly sent based on preset IP addresses without a DNS resolution in the prior art, which effectively avoids a DNS hijacking occurred in a DNS resolution process, thereby achieving an objective that a target address can be securely accessed through a normal HTTP request of the client.

In order to better understand the method as shown in FIG. 1 and FIG. 2, as refinement and expansion of the foregoing implementation, detailed description of the foregoing implementation will be made in the embodiments of the present disclosure.

In the embodiments of the present disclosure, when the HTTP request sent by the client is sent to the transition server based on the preset IP address in the transition server, the HTTP request of the client can be sent to the transition server based on the preset virtual IP address. A virtual IP is an IP address not connected with a particular computer or a network interface card in a computer. The HTTP request of the client is sent to the virtual IP address. However, all data still pass through a real network interface. In the embodiments of the present disclosure, since a request from the client is directly sent to the transition server corresponding to the virtual IP address instead of a DNS server for a domain name resolution in the prior art, occurrence of a DNS hijacking can be effectively avoided.

In a practical process of sending a request from the client to a virtual IP address, there may be multiple (at least two) virtual IP addresses. When multiple virtual IP addresses are provided, a request from the client can be sent to the transition server by selecting different virtual IP addresses according to a service type of the request. For example, when two preset virtual IP addresses (VIP-1 and VIP-2) are provided, a request from a finance department may use the VIP-1, a request from an administrative department may use the VIP-2, the transition server uses the two preset virtual IP addresses to receive a network request from the client, forward a received request on the VIP-1 to a corresponding execution server 1, and forward a received request on the VIP-2 to a corresponding execution server 2. Multiple requests from the client are forwarded to different execution servers by means of different virtual IP addresses, in this way, load equalization of the execution servers can be ensured, and tense processing resources caused because a large number of requests are borne by the same execution server are voided.

After a request from the client is sent to the transition server based on a preset virtual IP address through the foregoing implementation, in the embodiments of the present disclosure, it is still required to forward the request from the client to the execution server really executing the request from the client. Since the transition server in the embodiments of the present disclosure is a unique entry point receiving a request from the client, the transition server needs to forward a large number of requests from the client to the execution server. If all requests from the client are forwarded to the same execution server, an overload of the execution server may likely be caused, and an operating efficiency of the execution server may be affected, thus causing a failure in processing. Therefore, the transition server in the embodiments of the present disclosure needs to forward a request from the client according to certain rules. Specifically, as an alternative implementation, the transition server in the embodiments of the present disclosure can forward a request from the client to a target execution server according to a load condition of the execution server. In this implementation, multiple execution servers including a target execution server have the same content and provide the same service. When a request from the client arrives, the transition server only needs to select a target execution server having a normal load condition (lower than a load condition prewarning value) from the execution servers according to the load condition of each execution server, and forward the request from the client to the selected target execution server. Further, the transition servers may record this scheduling, and when other packets of the request from the client arrive, the packets may also be forwarded to the previously selected target execution server.

As another alternative implementation, the transition server in the embodiments of the present disclosure also can forward a request from the client to a corresponding execution server according to the content of the request from the client. In this implementation, each execution server can provide different services, and when a request from the client arrives, the transition server can select a corresponding execution server to execute the request according to the content of the request. In this case, the client only knows a virtual IP address configured by the transition server, which is in charge of forwarding the request from the client to a corresponding execution server according to the content of the request from the client. For example, when a transition server receives a request sequence BBCDBCD sent by the client, the transition server can send all requests B to an execution server 1 according to contents of the requests, and send requests C and D to an execution server 2, namely, a request sequence BBB is processed by the execution server 1, and a request sequence CDCD is processed by the execution server 2. Through this implementation, it can be avoided an overload operation of a server because a large number of requests are forwarded to one execution server.

The execution server in the embodiments of the present disclosure records a domain name resolution result, namely, operator information corresponding to each IP address as well as domain name and geographical location information configured. Therefore, after the transition server forwards a request from the client to the execution server, it is required to search for a corresponding domain name resolution result from the execution server according to the request. In a practical process of searching for a domain name resolution result, first of all it is required to acquire an egress IP address of the request, namely, remote address information of the client is acquire. In actual situation, since IP address information carried in an HTTP request header can be counterfeited, an IP address carried in the request header is untrusted. However, an HTTP is a protocol for transferring information between two computers (generally a server and a client) by using a TCP. Therefore, remote address information of the client can be obtained from a TCP connection, namely, an egress IP of the request. After obtaining the egress IP of the request from the client, egress IP addresses and corresponding domain name resolution results recorded in the execution server can be traversed according to the egress IP of the request from the client. The execution server in the embodiments of the present disclosure is configured with IPlib, and the IPlib includes remote address information (egress IP address information) of the client as well as corresponding Internet Service Provider (ISP) information and Geo Location information. In other words, the execution server is similar to a configured IP database, which includes an egress IP address field and corresponding information data, where the corresponding information data generally includes information of countries, regions (provinces/states), cities, streets, longitudes and latitudes and ISP providers, etc. In a process of traversing information recorded in the execution server, a corresponding domain name resolution result is searched for from the execution server according to the egress IP address of the request from the client. After searching out the corresponding domain name resolution result from the execution server, the corresponding domain name resolution result can be transferred and returned to the client by means of the transition server. Therefore, the client is allowed to see that the domain name resolution result comes from a preset IP address.

In the embodiments of the present disclosure, by configuring ISP information in the execution server, it can be effectively avoided obtaining an invalid domain name resolution result of a wrong ISP provider when a user inaccurately sets a DNS server.

As an application of the method as shown in FIG. 1, embodiments of the present disclosure provide an apparatus for implementing an automobile control system, which is mainly positioned in a transition server, as shown in FIG. 3, the apparatus includes: a receiving unit 31, a forwarding unit 32, and a returning unit 33, where

the receiving unit 31 is configured to receive a request from a client;

the forwarding unit 32 is configured to forward the request to an execution server and receive a domain name resolution result returned by the execution server; and

the returning unit 33 is configured to return the domain name resolution result to the client.

Further, the receiving unit 31 is configured to receive a request sent by the client according to preset IP addresses of the transition server, where the preset IP addresses are preset virtual IP addresses.

Further, at least two preset virtual IP addresses are provided, and the receiving unit 31 is configured to receive a request sent by the client according to different virtual IP addresses selected according to service types.

Further, the forwarding unit 32 is configured to forward the request to a target execution server according to a load condition of the execution server, and is further configured to forward the request to a corresponding execution server according to a content of the request.

According to the apparatus for implementing a domain name system provided by the embodiments of the present disclosure, requests can be uniformly sent by a client to a transition server based on preset IP addresses of the transition server, the received requests are forwarded by the transition server to an execution server, and a corresponding domain name resolution result is searched out from record information of the execution server and returned to the client. In the present disclosure, a request sent by the client can be directly sent based on preset IP addresses without a DNS resolution in the prior art, which effectively avoids a DNS hijacking occurred in a DNS resolution process, thereby achieving an objective that a target address can be securely accessed through a normal HTTP request of the client.

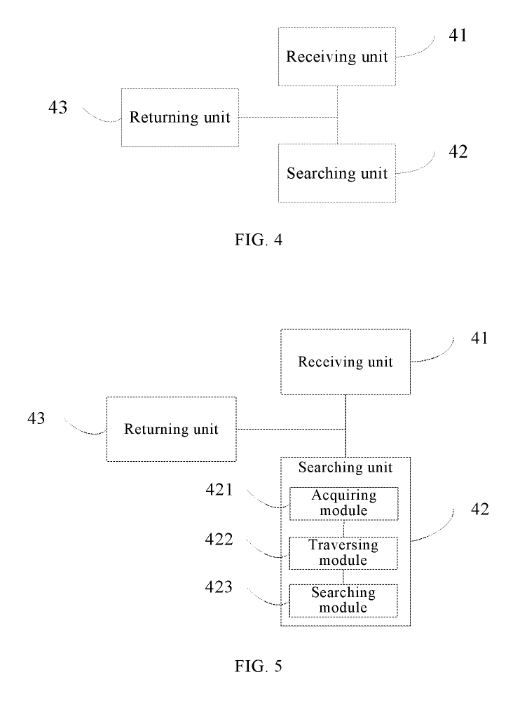

As an application of the method as shown in FIG. 2, embodiments of the present disclosure provide an apparatus for implementing a domain name system, which is mainly positioned in an execution server, as shown in FIG. 4, the apparatus includes: a receiving unit 41, a searching unit 42, and a returning unit 43, where

the receiving unit 41 is configured to receive a request forwarded by a transition server from a client;

the searching unit 42 is configured to search for a self-configured domain name resolution result corresponding to the request according to the request; and

the returning unit 43 is configured to return the domain name resolution result corresponding to the request to the transition server.

Further, as shown in FIG. 5, the searching unit 42 includes:

an acquiring module 421, configured to acquire an egress IP address of the request;

a traversing module 422, configured to traverse egress IP addresses configured in the execution server and domain name resolution results corresponding to the egress IP addresses; and

a searching module 423, configured to search for a corresponding domain name resolution result from the execution server according to the egress IP address of the request.

According to the apparatus for implementing a domain name system provided by the embodiments of the present disclosure, requests can be uniformly sent by a client to a transition server based on preset IP addresses of the transition server, the received requests are forwarded by the transition server to an execution server, and a corresponding domain name resolution result is searched out from record information of the execution server and returned to the client. In the present disclosure, a request sent by the client can be directly sent based on preset IP addresses without a DNS resolution in the prior art, which effectively avoids a DNS hijacking occurred in a DNS resolution process, thereby achieving an objective that a target address can be securely accessed through a normal HTTP request of the client.

Furthermore, by configuring ISP information in the execution server, the apparatus for implementing a domain name system provided by embodiments of the present disclosure can effectively avoid obtaining an invalid domain name resolution result of a wrong ISP provider when a user inaccurately sets a DNS server.

In allusion to the foregoing apparatus for implementing a domain name system, it is to be noted that functions of each unit module used in the embodiments of the present disclosure can be implemented through a hardware processor.

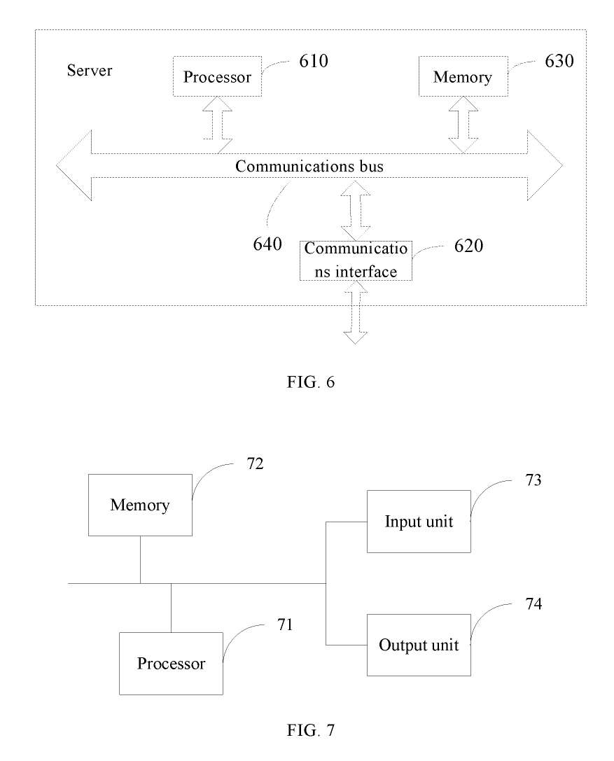

FIG. 6 illustrates a schematic structural diagram of a server, as shown in FIG. 6, the server can include: a processor 610, a communications interface 620, a memory 630 and a communications bus 640, where the processor 610, the communications interface 620 and the memory 630 complete communications among each other through the communications bus 640. The communications interface 620 can be configured to implement information transmission between the server and the client. The processor 610 can invoke a logic instruction in the memory 630 to execute the following method: sending a request of a client to a transition server based on a preset IP address; forwarding, by the transition server, the request of the client to an execution server; searching for a corresponding domain name resolution result from the execution server according to the request; and returning the corresponding domain name resolution result to the client.

In addition, when a logic instruction in the foregoing memory 630 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for implementing a domain name system mentioned by embodiments of the present disclosure.

FIG. 7 is a block diagram of an electronic device which is configured to perform the methods for implementing a domain name system according to an embodiment of the present disclosure. As shown in FIG. 7, the device includes:

one or more processors 71 and memory 72. A processor 71 is showed in FIG. 7 for an example.

Device which is configured to perform the methods for implementing a domain name system can also include: input unit 73 and output unit 74.

Processor 71, memory 72, input unit 73 and output unit 74 can be connected by BUS or other methods, and BUS connecting is showed in FIG. 7 for an example.

Memory 72 can be used for storing non-transitory software program, non-transitory computer executable program and modules as a non-transitory computer-readable storage medium, such as corresponding program instructions/modules for the methods for implementing a domain name system mentioned by embodiments of the present disclosure (such as shown in FIG. 3, receiving unit 31, forwarding unit 32 and returning unit 33). Processor 71 performs kinds of functions and implementing a domain name system of the electronic device by executing non-transitory software program, instructions and modules which are stored in memory 72, thereby realizes the methods for implementing a domain name system mentioned by embodiments of the present disclosure.

Memory 72 can include program storage area and data storage area, thereby the operating system and applications required by at least one function can be stored in program storage area and data created by using the device for implementing a domain name system can be stored in data storage area. Furthermore, memory 72 can include high speed Random-access memory (RAM) or non-volatile memory such as magnetic disk storage device, flash memory device or other non-volatile solid state storage devices. In some embodiments, memory 72 can include long-distance setup memories relative to processor 71, which can communicate with the device for implementing a domain name system by networks. The examples of said networks are including but not limited to Internet, Intranet, LAN, mobile Internet and their combinations.

Input unit 73 can be used to receive inputted number, character information and key signals causing user configures and function controls of the device for implementing a domain name system. Output unit 74 can include a display screen or a display device.

The said module or modules are stored in memory 72 and perform the methods for implementing a domain name system when executed by one or more processors 71.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for implementing a domain name system, implemented by a transition server, comprising:
receiving a request from a client, wherein the transition server has preset IP addresses;
forwarding the request to an execution server and receiving a domain name resolution result returned by the execution server; and
returning the domain name resolution result to the client.

2. The method according to claim 1, wherein the receiving, by the transition server, a request from a client comprises:
receiving, by the transition server, a request sent by the client according to the preset IP addresses of the transition server, wherein the preset IP addresses are preset virtual IP addresses.

3. The method according to claim 2, wherein at least two preset virtual IP addresses are provided; and
the receiving, by the transition server, a request from a client comprises:
receiving, by the transition server, a request sent by the client according to different virtual IP addresses selected according to service types.

4. The method according to claim 1, wherein the forwarding the request to an execution server comprises:
forwarding, by the transition server, the request to a target execution server according to a load condition of the execution server; and
forwarding, by the transition server, the request to a corresponding execution server according to a content of the request.

5. An electronic device, comprising:
at least one processor; and
a memory communicably connected with the at least one processor for storing instructions executable by the at least one processor, wherein execution of the instructions by the at least one processor causes the at least one processor to:
receive a request from a client, wherein the transition server has preset IP addresses;
forward the request to an execution server and receive a domain name resolution result returned by the execution server; and
return the domain name resolution result to the client.

6. The electronic device according to claim 5, wherein the receiving a request from a client comprises:
receiving a request sent by the client according to the preset IP addresses of the electronic device, wherein the preset IP addresses are preset virtual IP addresses.

7. The electronic device according to claim 6, wherein at least two preset virtual IP addresses are provided; and
the receiving a request from a client comprises:
receiving a request sent by the client according to different virtual IP addresses selected according to service types.

8. The electronic device according to claim 5, wherein the forwarding the request to an execution server comprises:
forwarding the request to a target execution server according to a load condition of the execution server; and
forwarding the request to a corresponding execution server according to a content of the request.

9. An electronic device, comprising:
at least one processor; and
a memory communicably connected with the at least one processor for storing instructions executable by the at least one processor, wherein execution of the instructions by the at least one processor causes the at least one processor to:
receive a request forwarded by a transition server from a client;
search for a self-configured domain name resolution result corresponding to the request according to the request; and
return the domain name resolution result corresponding to the request to the transition server.

10. The electronic device according to claim 9, wherein the searching for a self-configured domain name resolution result corresponding to the request according to the request comprises:
acquiring an egress IP address of the request;
traversing egress IP addresses configured in the electronic device and domain name resolution results corresponding to the egress IP addresses; and
searching for a corresponding domain name resolution result from the electronic device according to the egress IP address of the request.
